(19) United States
(12) Patent Application Publication
(10) Pub. No.: US 2017/0019665 A1
(43) Pub. Date: Jan. 19, 2017

(54) Method and Apparatus of Single Sample Mode for Video Coding

(71) Applicant: HFI Innovation Inc., Zhubei City, Hsinchu County (TW)

(72) Inventors: Yi-Wen CHEN, Taichung City (TW); Jian-Liang LIN, Su'ao Township, Yilan County (TW); Yu-Chen SUN, Keelung City (TW)

(21) Appl. No.: 15/123,825

(22) PCT Filed: Mar. 11, 2015
(86) PCT No.: PCT/CN2015/073984

§ 371 Date: Sep. 6, 2016

Related U.S. Application Data
(60) Provisional application No. 61/950,929, filed on Mar. 11, 2014.

(51) Int. Cl. H04N 19/105; H04N 19/597; H04N 19/96

(52) U.S. Cl. CPC H04N 19/105; H04N 19/96; H04N 19/597; H04N 19/176

(57) ABSTRACT

A method and apparatus of video coding including a Single Sample Mode are disclosed. Embodiments according to the present invention construct a sample candidate list comprising one or more sample candidates from previously reconstructed neighboring samples of the current depth block or the current texture block. A sample candidate is selected from the sample candidate list and the selected sample candidate is used as reconstructed samples for the current depth block or the current texture block. A sample candidate index indicating the selected sample candidate can be signaled at the encoder side or parsed at the decoder side. Alternatively, the sample candidate index can be derived implicitly.

### CROSS REFERENCE TO RELATED APPLICATIONS

The present invention claims priority to U.S. Provisional Patent Application, Ser. No. 61/950,929, filed on Mar. 11, 2014. The U.S. Provisional Patent Application is hereby incorporated by reference in its entirety.

### TECHNICAL FIELD

The present invention relates to video coding having smooth contents. In particular, the present invention relates to depth coding or video using having smooth contents.

### BACKGROUND

Three-dimensional (3D) television has been a technology trend in recent years that is targeted to bring viewers sensational viewing experience. Multi-view video is a technique to capture and render 3D video. The multi-view video is typically created by capturing a scene using multiple cameras simultaneously, where the multiple cameras are properly located so that each camera captures the scene from one viewpoint. The multi-view video with a large number of video sequences associated with the views represents a massive amount data. Accordingly, the multi-view video will require a large storage space to store and/or a high bandwidth to transmit. Therefore, multi-view video coding techniques have been developed in the field to reduce the required storage space and the transmission bandwidth. In three-dimensional and multi-view coding systems, the texture data as well as depth data are coded.

Currently, extensions of HEVC (High Efficiency Video Coding) are being developed, including range extensions (RExt) and 3D extensions. The range extension targets at non-4:2:0 color formats, such as 4:2:2 and 4:4:4, and video data with higher bit-depths such as 12, 14 and 16 bit-per-sample while the 3D extension targets at the coding of multi-view video with depth data.

One of the mostly likely applications utilizing RExt is screen sharing, over wired-connection or wireless. For video containing screen contents, coding tools have been developed by taking into consideration of the specific characteristics of screen-content and have been demonstrated to achieve significant gains in coding efficiency. Among them, the palette coding (a.k.a. major color based coding) techniques represent block of pixels using indices to the palette (major colors), and encode the palette and the indices by exploiting spatial redundancy.

In order to support the auto-stereoscopic multi-view display, multi-view video plus depth (MVD) format was introduced as a new 3D video format as described in JCT3V-G1005 (Zhang et al., Test Model 7 of 3D-HEVC and MV-HEVC, Joint Collaborative Team on 3D Video Coding Extension Development of ITU-T SG 16 WP 3 and ISO/IEC JTC 1/SC 29/WG 11 7th Meeting: San Jose, US, 11-17 Jan. 2014, Document: JCT3V-G1005). The MVD format consists of a texture image and its associated depth map. Unlike a texture image representing the luminance and chrominance information of an object, a depth map represents the distance between an object and a camera as a gray scale image. The depth map is generally employed as non-visual information for virtual view rendering. The MVD format enables the 3D display to generate virtual texture images for arbitrary views by using the depth image based rendering (DIBR) technique. Usually only a small number of the views are needed to be transmitted. The MVD format is being widely used as an input format for the 3D video coding.

The depth maps and screen content video typically show different signal characteristics compared to natural video data. In general, both depth maps and screen contents contain substantial smooth areas with similar pixel values. Furthermore, the pixels within the smooth areas often even share a same pixel value within an area.

It is desirable to develop techniques to further improve the coding efficiency through new prediction mode and syntax by taking into consideration of the characteristics of smooth areas in depth maps and screen contents.

### SUMMARY

A method and apparatus of video coding including a Single Sample Mode are disclosed. Embodiments according to the present invention construct a sample candidate list comprising one or more sample candidates from previously reconstructed neighboring samples of the current depth block or the current texture block. A sample candidate is selected from the sample candidate list and the selected sample candidate is used as reconstructed samples for the current depth block or the current texture block. A sample candidate index indicating the selected sample candidate can be signaled at the encoder side or parsed at the decoder side. Alternatively, the sample candidate index can be derived implicitly.

The sample candidate list may include one or more sample candidates in a predefined order. The sample candidate list may be pruned before or after a sample candidate is inserted. The previously reconstructed neighboring samples may include spatial neighboring samples, temporal neighboring samples, inter-view neighboring samples, or any combination of them. The sample candidate list may further include at least one new sample candidate derived by adding an offset value to one existing sample candidate in the sample candidate list for the current texture block in screen-content video coding or for the current depth block in depth coding. The sample candidate list may also further include at least one default sample candidate corresponding to zero, a middle value of a maximum allowed sample value, the maximum allowed sample value, a maximum value of the reconstructed neighboring samples, a majority of the reconstructed neighboring samples, or a median of the previously reconstructed neighboring samples.

A control flag can be signaled in the current depth block or the current texture block to enable or disable said Single Sample Mode processing for the current depth block or the current texture block. The current depth block or the current texture block corresponds to a coding unit (CU). The target size of the sample candidate list can be signaled in a block level, slice level, picture level, sequence level or view level of a bitstream including coded data associated with the current depth block or the current texture block. The target size of the sample candidate list can also be determined implicitly according to an identical process at both the encoder side and the decoder side.

The target size of the sample candidate list can be fixed to a positive integer N and the target size of the sample candidate list is either pre-specified or signaled in a bitstream including coded data associated with the current depth block or the current texture block. If a current number of sample candidates is less than N, one or more additional sample candidates can be added to the sample candidate list. If a current number of sample candidates is larger than N, only first N sample candidates according to a priority order will be retained in the sample candidate list. The priority order can be pre-specified or adaptively derived according to statistics of coded sample index. In one example, the target size of the sample candidate list is fixed to 2. In this case, the first sample candidate corresponds to a middle sample of the column of spatial neighboring samples to a left side of the current block and the second sample candidate corresponds to the middle sample of the row of spatial neighboring samples on the top side of the current block. If a sample candidate in the sample candidate list is empty, the empty sample candidate can be replaced by a new sample candidate generated by adding an offset to an available sample candidate in the sample candidate list. If the current number of sample candidates is 1 or less, there is no need to signal the sample candidate index for identifying the selected sample candidate.

The Single Sample Mode may further comprise signaling residues between the selected sample candidate and the current depth block or the current texture block at the encoder side, or parsing the residues at the decoder side. The residual will be used in the decoding process of the current depth block or the current texture block. The residues can be coded using a single representative residual value or using a quad-tree process. Furthermore, a flag may be signaled to indicate whether the single representative residual value or the quad-tree process is used code the residues.

### BRIEF DESCRIPTION OF THE DRAWINGS

FIG. 1A illustrates an example of spatial neighboring samples that are used to derive sample candidates for Single Sample Mode coding.

FIG. 1B illustrates an example of temporal neighboring samples that are used to derive sample candidates for Single Sample Mode coding.

FIG. 1C illustrates an example of inter-view neighboring samples that are used to derive sample candidates for Single Sample Mode coding.

FIG. 2A illustrates an example of spatial neighboring samples that are used to derive sample candidates for Single Sample Mode coding.

FIG. 2B illustrates an example of sample candidate list comprising two spatial neighboring samples that are used to derive sample candidates for Single Sample Mode coding.

FIG. 3 illustrates an exemplary flowchart for a system incorporating Single Sample Mode coding according to an embodiment of the present invention.

### DETAILED DESCRIPTION

As mentioned above, the depth maps in a 3D system and the texture data corresponding to screen contents often include significant smooth areas. A coding method is disclosed herein to take the advantage of the smoothness in the depth maps and video data corresponding to screen contents to improve coding efficiency. Accordingly, a coding method of the present invention uses a single sample value to represent a smooth area of video data (either depth data of screen content data). The coding mode termed as “Single Sample Mode” or “Single Sample Coding Mode” in this disclosure. When a block is coded in the Single Sample Coding Mode, a whole current block is coded as a single pixel value. In other words, when a block coded in the Single Sample Coding Mode, the whole block is reconstructed by filling all pixels in the block with a single sample value (i.e., either a depth value or a pixel value). The pixel may correspond to any color format (e.g., YUV444, YUV420, YUV422, YUV400 or RGB).

The pixel value used for filling up the current block can be derived from previously decoded pixels. A sample candidate list is first constructed for a block coded as Single Sample Coding Mode. At the decoder side, the block is filled up with single value of the selected candidate from the sample candidate list. The detail of the proposed Single Sample Coding mode is described as follows. The Single Sample Mode can also be referred as “Single Depth Mode” when it is applied to depth coding. The Single Sample Mode can also be referred as “Single Color Mode” when it is applied to video coding of texture data.

Construction of Sample Candidate List

According to the present invention, a sample candidate list comprising one or more sample candidates for a block of video data coded in the Single Sample Coding Mode is constructed first. The size of the sample candidate list can be fixed or adaptive. For example, the size of the sample candidate list can be fixed to N, where N is a positive integer. While the size of the sample candidate list is fixed to N, the actual sample candidate list may be smaller since there may be redundancy in the candidate list and some sample candidates may not be available. Therefore, the intended candidate list size is referred as the “target size” in this disclosure. This target size may be different from the actual size of the candidate list.

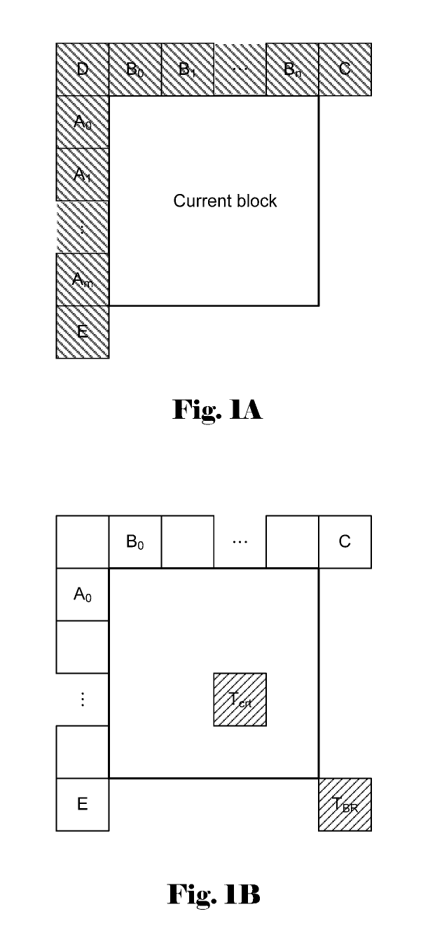

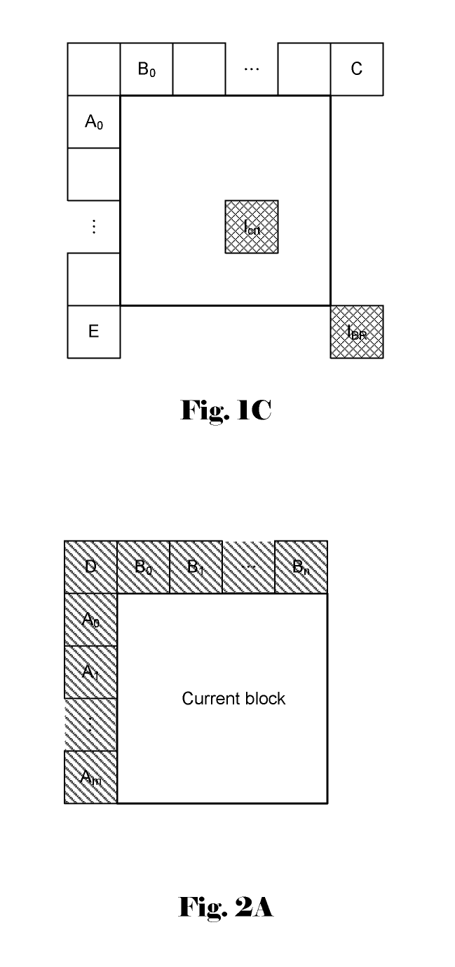

The sample candidate list is constructed by inserting one or more sample candidates in a predefined order into the sample candidate list. The sample candidates can be selected from the neighboring pixels of the current block (e.g., coding unit, CU). According to the picture type associated with the neighboring pixels, the sample candidates can be classified into different types. For example, FIG. 1A illustrates an example of spatial neighboring pixels that can be used to derive the sample candidates. FIG. 1B illustrates an example of temporal neighboring pixels that can be used to derive the sample candidates. FIG. 1C illustrates an example of inter-view neighboring pixels that can be used to derive the sample candidates. While specific examples are illustrated in FIG. 1A through FIG. 1C, the neighboring pixels are not limited to these examples. Any previously reconstructed pixels may be used to construct the sample candidate list.

a. Spatial Sample Candidates

As shown in FIG. 1A, where each small square represents one pixel, the spatial neighboring pixels include those reconstructed pixels around the current block in the current picture (i.e., A₀-Aₘ, B₀-Bₙ, D, C and E). The spatial neighboring pixels are in the same picture as the current block. While the specific spatial neighboring pixels are shown, other spatial reconstructed pixels may also be used.

b. Temporal Sample Candidates

As shown in FIG. 1B, the temporal neighboring pixels are those pixels co-located in the temporal reference picture of the current block. In other words, the temporal neighboring are within or neighboring to the corresponding block in a temporal reference picture. The specific exemplary temporal pixels shown in FIG. 1B correspond to a co-located temporal pixel at the lower-right side (T_{Ctr}) of the central block location and a co-located temporal pixel diagonally across from the lower-right corner pixel of the co-located block (i.e., T_{Br}). While the specific temporal neighboring pixels are shown, other temporal reconstructed pixels may also be used.

c. Inter-View Sample Candidates

As shown in FIG. 1C, the inter-view neighboring pixels are those pixels in corresponding block location of the inter-view reference picture of the current block. The specific exemplary inter-view pixels shown in FIG. 1C correspond to a pixel at the lower-right side (I_{Ctr}) of the central block location of the corresponding inter-view block and a pixel location (i.e., I_{Br}) diagonally across from the lower-right corner pixel of the corresponding inter-view block. While the specific inter-view neighboring pixels are shown, other inter-view reconstructed pixels may also be used.

d. Additional Sample Candidates

In addition to the spatial, temporal and inter-view candidates disclosed above, other samples may also be inserted into the sample candidate list. For example, the additional sample candidates may be a sample with a default value such as zero, middle value of the maximum allowed value, the maximum allowed value, the maximum of the neighboring pixels, the majority of the neighboring pixel, or the median of the neighboring pixels. Furthermore, the additional sample candidates may be a modified sample based on the sample derived from the neighboring sample. For example, the additional sample candidate can be derived by adding a constant value to one of the neighboring sample candidate. In another example, the additional candidates can be derived from a look up table that stores the top N majority pixel values. The look up table can be designed based on the statistics of video data at different levels such as the sequence level, picture level, slice level, coding block level (e.g. coding unit in HEVC) or prediction block level (e.g. prediction unit in HEVC). When the actual size of the candidate list is smaller than the target size, additional sample candidates can be added to the sample candidate list.

Pruning Process of Sample Candidate List

An optional redundancy pruning process can be applied to the candidate list in order to improve the coding efficiency. For example, a sample candidate will not be inserted into the candidate list if it is identical to any of the previously derived sample candidates. To reduce the complexity, a partial redundancy process may be applied, where the redundancy checking is only applied to some designated candidates. Moreover, the redundancy pruning process can be applied to each color channel (e.g., Y, Cr, Cr, R, G, B or depth) independently or jointly. After pruning, the size of the candidate list may be smaller than the target size. Additional sample candidates can be added to candidate list.

Residual Signaling of Single Sample Mode

While a block of depth data or texture data coded in the Single Sample Mode can be reconstructed by filling up all pixels in the block by a selected sample, the prediction residual can be selectively signaled as an optional process. When residual is signaled for the Single Sample Mode, the conventional residual quad-tree transform and residual signaling in HEVC can be used to signal the residual. Alternatively, a single delta value can be signaled for the entire Single Sample Mode coded block as a representative residual value.

Signaling of Single Sample Mode

One flag can be used to signal the enabling/disabling of the Single Sample Coding Mode. This flag can be signaled in the coding unit (CU) level to indicate the enabling/disabling of the Single Sample Coding Mode for the entire CU. This flag can also be signaled in the prediction unit (PU) level to indicate the enabling/disabling of the Single Sample Coding Mode for the PU.

High level syntax can also be signaled in the slice header, picture parameter set (PPS), sequence parameter set (SPS), video parameter set (VPS) to enable or disable the Single Sample Mode for the corresponding entire slice, picture, sequence or video data associated with the video coding. The size of the sample candidate list could also be signaled in the bitstream in different levels (e.g., slice header, PPS, SPS or VPS).

For each Single Sample Mode coded block, a sample index can be signaled to indicate the candidate selected from the sample candidate list for reconstructing the Single Sample Mode coded block. The truncated unary or any other coding methods can be applied for binarization of the sample index. Furthermore, context-depending entropy coding can be applied to the binarized sample index. For example, the first bin of the binary codeword of the sample index is context coded and the rest bins are bypass coded.

When the size of the sample candidate list is smaller than or equal to one, the signaling of sample index can be omitted.

As mention before, residual can be optionally signaled for the Single Sample Mode coded block. If the optional residual signaling is used, a flag may be further signaled to indicate whether a single delta DC or normal residual is used for the Single Sample Mode coded block. When it is a normal block with residual, a conventional residual signaling syntax based on quad-tree coding as used in HEVC can be utilized to signal the residual. In a single delta DC is used for the residual, only a delta DC is signaled for the Single Sample Mode coded block.

Restriction of Single Sample Mode

The Single Sample Mode can be selectively applied according to the information associated with the coding block such as the size of the coding block or the partitioning type of the coding block. For example, the Single Sample Mode is only applied to the 32×32 and 64×64 CUs (blocks). In another example, the Single Sample Mode is only applied to the CU with partitioning type 2N×2N.

Encoder Decision of Single Sample Mode

The decision regarding whether Single Sample Mode is enabled or disabled can be made for a current picture/slice based on information associated with the underlying video data. Two examples are illustrated as follows:

1. Encoder can gather statistics of the pixels in the current picture. If the smooth area of current picture is larger than a threshold, the Single Sample Mode is enabled for current picture/slice; otherwise, the Single Sample Mode is disabled for current picture/slice. There are various known techniques of smooth area detection in the literature. For example, the histogram of the pixels in the current picture can be used as a measurement of smoothness detection. If the total number of the top N majority pixel values is larger than a threshold, it implies that the majority pixels are concentrated at limited values. This is an indication of smoothness in the picture and the Single Sample Mode is enabled for current picture/Slice. Otherwise, the Single Sample Mode is disabled.

2. The pixel statistic can be gathered based on the previously reconstructed picture instead of the current picture. For example, the statistics can be gathered from the previously reconstructed picture with temporal layer equal to current temporal layer minus one. An example of the detailed algorithm is shown below.

```
If current temporal layer =0
{
    enable Single Sample Mode;
}
Else
{
  If the Single Sample Mode enabling ratio in the previously
  reconstructed picture with
        (current temporal layer −1) > Threshold
    enabled Single Sample Mode;
  Else
    disable Single Sample Mode;
}
```

Single Sample Mode Vs Intra Prediction Mode

The Single Sample Mode can be viewed as an Intra prediction mode, particularly the Intra DC mode, so that the following Intra coded blocks can form Intra prediction using the current Single Sample coded block as previously reconstructed data.

In a non-I-Slice (e.g. P-Slice or B-Slice), the Single Sample Mode may include the temporal or inter-view candidates in the sample candidate list. In an I-Slice, the Single Sample Mode can only include the spatial candidates in the sample candidate list.

Examples of Single Sample Mode

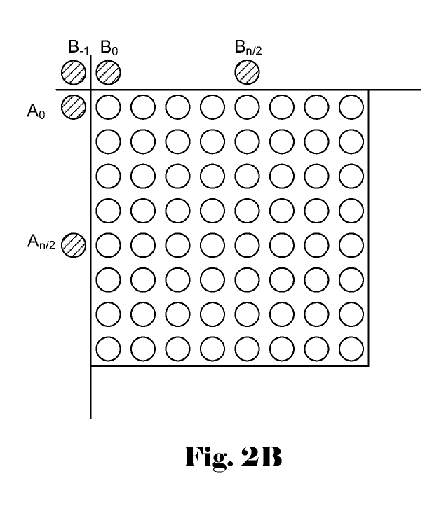

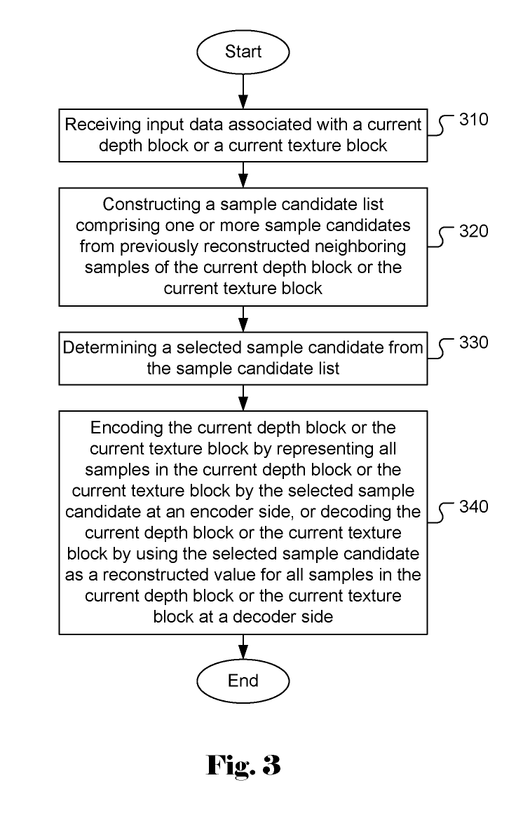

In one example, the sample candidate list with fixed size for depth coding is constructed by inserting only the spatial neighboring depth pixels according to a predefined order. For example, the pre-defined order may correspond to A₀, . . . , Aₘ, B₀, . . . , Bₙ and D as shown in FIG. 2A. A full redundancy checking can be applied during the construction of the depth sample candidate list. Default sample candidate (e.g., a middle depth value) can be used to fill the candidate list once the list still has empty entries.

In another example, a simplified pruning process is used, where the candidate Aₘ is only compared to the candidate A₀ in the redundancy check; the candidate Bₙ is only compared to the candidate B₀ in the redundancy check.

In yet another example, the size of sample candidate list is fixed to 2 for depth coding. In other words, two sample candidates are included in the sample candidate list. The sample candidate list is constructed using a first sample candidate in a middle of left neighboring column samples of the current block. If there are n samples in the left neighboring column samples, the middle sample corresponds to A_{n/2} as shown in FIG. 2B. After the first sample candidate is inserted, a second sample candidate in a middle of top neighboring row samples of the current block is inserted. If there are n samples in the top neighboring row samples, the middle sample corresponds to B_{n/2} as shown in FIG. 2B.

A full redundancy checking can be applied during the construction of the pixel sample candidate list. Default sample candidate can be used to fill the candidate list. For color video coding with screen contents, the default sample may have individual default colors (e.g., three default values for three color components).

The performance of a video coding system incorporating Single Sample Mode according to an embodiment of the present invention is compared to that of a conventional system based on HTM-11.0 (High Efficiency Video Coding, HEVC Test Model). The embodiment according to the present invention uses Single Sample Mode for the depth data, where the sample candidate list is derived from the spatial neighboring samples as shown in FIG. 2B and no residual is signaled. The performance comparison is based on different sets of test data listed in the first column. The test results of the system incorporating an embodiment of the present invention under the common test conditions (CTC) and under the all-Intra (AI) test conditions are shown in Table 1 and Table 2, respectively. As shown in the tables, the Single Sample Mode can achieve 0.29% and 0.34% BD-rate saving in both CTC and AI test conditions respectively.

TABLE 1

| | | | | Video | Video | Synth | | | |
|---|---|---|---|---|---|---|---|---|---|
| | | | | PSNR/ | PSNR/ | PSNR/ | | | |
| | | | | video | total | total | Enc | Dec | Ren |
| | Video 0 | Video 1 | Video 2 | bitrate | bitrate | bitrate | time | time | time |
| Balloons | 0.00% | −0.06% | 0.08% | 0.00% | −0.02% | −0.13% | 99.8% | 98.6% | 98.1% |
| Kendo | 0.00% | −0.01% | 0.07% | 0.01% | −0.12% | −0.39% | 104.0% | 89.3% | 100.5% |
| Newspapercc | 0.00% | −0.07% | −0.06% | −0.01% | −0.02% | −0.25% | 101.9% | 106.8% | 101.6% |
| GhostTownFly | 0.00% | −0.06% | 0.13% | 0.02% | −0.23% | −0.76% | 100.2% | 101.1% | 101.9% |
| PoznanHall2 | 0.00% | 0.07% | 0.00% | 0.00% | −0.05% | −0.13% | 100.8% | 99.9% | 99.1% |
| PoznanStreet | 0.00% | 0.30% | 0.19% | 0.06% | −0.03% | −0.10% | 102.9% | 94.3% | 97.7% |
| UndoDancer | 0.00% | 0.06% | 0.07% | 0.03% | 0.05% | −0.18% | 103.5% | 97.6% | 101.0% |
| Shark | 0.00% | −0.13% | 0.07% | −0.01% | −0.12% | −0.39% | 100.4% | 98.1% | 102.1% |
| 1024×768 | 0.00% | −0.04% | 0.03% | 0.00% | −0.05% | −0.26% | 101.9% | 98.2% | 100.0% |
| 1920×1088 | 0.00% | 0.05% | 0.09% | 0.02% | −0.08% | −0.31% | 101.6% | 98.2% | 100.3% |
| average | 0.00% | 0.01% | 0.07% | 0.01% | −0.07% | −0.29% | 101.7% | 98.2% | 100.2% |

TABLE 2

| | | | | Video | Video | Synth | | | |
|---|---|---|---|---|---|---|---|---|---|
| | | | | PSNR/ | PSNR/ | PSNR/ | | | |
| | | | | video | total | total | Enc | Dec | Ren |
| | Video 0 | Video 1 | Video 2 | bitrate | bitrate | bitrate | time | time | time |
| Balloons | 0.00% | 0.00% | 0.00% | 0.00% | −0.11% | −0.23% | 99.4% | 99.7% | 100.3% |
| Kendo | 0.00% | 0.00% | 0.00% | 0.00% | −0.12% | −0.28% | 98.3% | 100.5% | 95.9% |
| Newspapercc | 0.00% | 0.00% | 0.00% | 0.00% | −0.13% | −0.29% | 99.1% | 93.7% | 98.1% |
| GhostTownFly | 0.00% | 0.00% | 0.00% | 0.00% | −0.52% | −0.74% | 100.5% | 93.3% | 101.0% |
| PoznanHall2 | 0.00% | 0.00% | 0.00% | 0.00% | −0.21% | −0.25% | 99.2% | 94.2% | 98.1% |
| PoznanStreet | 0.00% | 0.00% | 0.00% | 0.00% | −0.22% | −0.33% | 99.3% | 93.2% | 98.9% |
| UndoDancer | 0.00% | 0.00% | 0.00% | 0.00% | 0.01% | −0.01% | 99.0% | 95.3% | 102.7% |
| Shark | 0.00% | 0.00% | 0.00% | 0.00% | −0.29% | −0.56% | 98.9% | 98.5% | 99.1% |
| 1024 × 768 | 0.00% | 0.00% | 0.00% | 0.00% | −0.12% | −0.27% | 98.9% | 98.0% | 98.1% |
| 1920 × 1088 | 0.00% | 0.00% | 0.00% | 0.00% | −0.25% | −0.38% | 99.4% | 94.9% | 100.0% |
| average | 0.00% | 0.00% | 0.00% | 0.00% | −0.20% | −0.34% | 99.2% | 96.0% | 99.3% |

FIG. 3 illustrates an exemplary flowchart of Single Sample Mode coding for depth data or texture data according to an embodiment of the present invention. The system receives input data associated with a current depth block or a current texture block as shown in step 310. For encoding, the input data associated with the current depth block or the current texture block corresponds to the depth samples or pixel values to be coded. For decoding, the input data associated with the current depth block or the current texture block corresponds to the coded depth data or coded video pixel data to be decoded. The input data associated with the current depth block may be retrieved from memory (e.g., computer memory, buffer (RAM or DRAM) or other media) or from a processor. A sample candidate list comprising one or more sample candidates is constructed from previously reconstructed neighboring samples of the current depth block or the current texture block as shown in step 320. A selected sample candidate is determined from the sample candidate list as shown in step 330. The current depth block or the current texture block is encoded by representing all samples in the current depth block or the current texture block by the selected sample candidate at an encoder side, or reconstructed by using the selected sample candidate as a reconstructed value for all samples in the current depth block or the current texture block at a decoder side as shown in step 340.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding for a block of depth data or texture data, the method comprising:
receiving input data associated with a current depth block or a current texture block;
if the current depth block or the current texture block is coded in Single Sample Mode, applying Single Sample Mode processing to the current depth block or the current texture block, wherein said Single Sample Mode processing comprising:
constructing a sample candidate list comprising one or more sample candidates from previously reconstructed neighboring samples of the current depth block or the current texture block;
determining a selected sample candidate from the sample candidate list; and
encoding the current depth block or the current texture block by representing all samples in the current depth block or the current texture block by the selected sample candidate at an encoder side, or decoding the current depth block or the current texture block by using the selected sample candidate as a reconstructed value for all samples in the current depth block or the current texture block at a decoder side.

2. The method of claim 1, further comprising signaling a sample candidate index at the encoder side or parsing the sample candidate index at the decoder side, wherein the sample candidate index is associated with the selected sample candidate.

3. The method of claim 1, wherein the selected sample candidate is indicated by a sample candidate index and the sample candidate index is derived implicitly.

4. The method of claim 1, wherein said constructing the sample candidate list comprising inserting one or more sample candidates in a predefined order into the sample candidate list.

5. The method of claim 1, wherein said constructing the sample candidate list comprising selectively pruning the sample candidate list before or after one sample candidate is inserted.

6. The method of claim 1, wherein the previously reconstructed neighboring samples include spatial neighboring samples, temporal neighboring samples, inter-view neighboring samples, or any combination thereof.

7. The method of claim 1, wherein the sample candidate list further comprising at least one new sample candidate derived by adding an offset value to one existing sample candidate in the sample candidate list for the current texture block in screen-content video coding or for the current depth block in depth coding.

8. The method of claim 1, wherein the sample candidate list further comprising at least one default sample candidate corresponding to zero, a middle value of a maximum allowed sample value, the maximum allowed sample value, a maximum value of the reconstructed neighboring samples, a majority of the reconstructed neighboring samples, or a median of the previously reconstructed neighboring samples.

9. The method of claim 1, wherein a control flag is signaled in the current depth block or the current texture block to enable or disable said Single Sample Mode processing for the current depth block or the current texture block, and wherein the current depth block or the current texture block corresponds to a coding unit (CU).

10. The method of claim 1, wherein a target size of the sample candidate list is signaled in a block level, slice level, picture level, sequence level or view level of a bitstream including coded data associated with the current depth block or the current texture block.

11. The method of claim 1, wherein a target size of the sample candidate list is determined implicitly according to an identical process at both the encoder side and the decoder side.

12. The method of claim 1, wherein a target size of the sample candidate list is fixed to a positive integer N and the target size of the sample candidate list is either pre-specified or signaled in a bitstream including coded data associated with the current depth block or the current texture block.

13. The method of claim 12, wherein if a current number of sample candidates is less than N, one or more additional sample candidates are added to the sample candidate list.

14. The method of claim 12, wherein if a current number of sample candidates is larger than N, only first N sample candidates according to a priority order are retained in the sample candidate list.

15. The method of claim 14, wherein the priority order is pre-specified or adaptively derived according to statistics of coded sample index.

16. The method of claim 12, wherein the target size of the sample candidate list is fixed to 2.

17. The method of claim 16, wherein the sample candidate list is constructed using a first sample candidate in a middle of a column of spatial neighboring samples to a left side of the current block and then using a second sample candidate in a middle of a row of spatial neighboring samples on a top side of the current block.

18. The method of claim 17, wherein if one sample candidate in the sample candidate list is empty, said one sample candidate being empty is replaced by a new sample candidate generated by adding an offset to an available sample candidate in the sample candidate list.

19. The method of claim 12, wherein if a current number of sample candidates is 1 or less, no sample candidate index is signaled for identifying the selected sample candidate.

20. The method of claim 1, further comprising signaling residues between the selected sample candidate and the current depth block or the current texture block at the encoder side, or parsing the residues and including the residual in said decoding the current depth block or the current texture block at the decoder side.

21. The method of claim 20, wherein the residues are coded using a single representative residual value or using a quad-tree process.

22. The method of claim 21, wherein a flag is signaled to indicate whether the single representative residual value or the quad-tree process is used for coding the residues.

23. An apparatus for video coding of a block of depth data or texture data in a video coding system, the apparatus comprising one or more electronic circuits configured to:
receive input data associated with a current depth block or a current texture block;
if the current depth block or the current texture block is coded in Single Sample Mode:
construct a sample candidate list comprising one or more sample candidates from previously reconstructed neighboring samples of the current depth block or the current texture block;
determine a selected sample candidate from the sample candidate list; and
encode the current depth block or the current texture block by representing all samples in the current depth block or the current texture block by the selected sample candidate, or decode the current depth block or the current texture block by using the selected sample candidate as a reconstructed value for all samples in the current depth block or the current texture block.
